(19) United States
(12) Patent Application Publication
(10) Pub. No.: US 2015/0348011 A1
(43) Pub. Date: Dec. 3, 2015

(54) SMART CARD AND METHOD FOR CONTROLLING SMART CARD TRADE

(71) Applicant: TENDYRON CORPORATION, Beijing (CN)

(72) Inventor: Dongsheng LI, Beijing (CN)

(21) Appl. No.: 14/654,818

(22) PCT Filed: Dec. 19, 2013
(86) PCT No.: PCT/CN2013/090011

§ 371 Date: Jun. 22, 2015

(30) Foreign Application Priority Data
Dec. 20, 2012 (CN) 201210557350.9

(51) Int. Cl. G06Q 20/34; G06Q 20/40

(52) U.S. Cl. CPC G06Q 20/341; G06Q 20/405

(57) ABSTRACT

A smart card and a method for controlling a smart card trade are provided. The method includes receiving a trade instruction from a card reader through an antenna; analyzing the trade instruction to obtain trade information; judging whether the trade information contains an amount; comparing the amount with a prestored first threshold if the trade information contains the amount; performing a trade operation according to the trade instruction if the amount is smaller than the first threshold; sending first comparison information to a security chip if the amount is greater than or equal to the first threshold; performing a validation operation according to the first comparison information, and sending validation success information to the chip of the smart chip by the security chip if the validation operation is successful; and performing the trade operation according to the validation success information and the trade instruction

### FIELD

The present disclosure relates to an electronic technical field, and more particularly to a smart card and a method for controlling a smart card trade.

### BACKGROUND

A traditional smart IC card is generally a smart IC card having a single function, such as a fuel card. Due to the lack of encryption and security protections, the smart IC card is usually used to implement a trade having a small trade amount. When the smart IC card is used to implement a trade having relatively larger trade amount in a non-contact manner, however, the trade security cannot be ensured.

During a non-contact trade of a traditional smart IC card, a chip of the smart IC card transmits information through a non-contact antenna. If the non-contact antenna receives a control instruction from a card reading device such as a POS or an ATM, the smart IC card is triggered to perform data transmission. As the smart IC card performs data transmission as long as the control instruction from the card reading device is received, regardless whether the user knows or not, a loss will occur to the user.

### SUMMARY

The present disclosure aims to solve at least one problem, such as insecurity of a smart IC card.

The main object of the present disclosure is to provide a method for controlling a smart card trade.

Another object of the present disclosure is to provide a smart card.

In order to achieve the above objects, technical solutions of the present disclosure are implemented as follows.

A first aspect of the present disclosure provides a method for controlling a smart card trade, comprising: receiving by a chip of the smart card a trade instruction from a card reader through an antenna; analyzing by the chip of the smart card the trade instruction to obtain trade information; judging by the chip of the smart card whether the trade information contains an amount; comparing by the chip of the smart card the amount with a prestored first threshold if the trade information contains the amount; performing by the chip of the smart card a trade operation according to the trade instruction if the amount is smaller than the first threshold; sending first comparison information to a security chip if the amount is greater than or equal to the first threshold; performing a validation operation according to the first comparison information, and sending validation success information to the chip of the smart chip by the security chip if the validation operation is successful; and performing by the chip of the smart card the trade operation according to the validation success information and the trade instruction.

Further, performing a validation operation by the security chip comprises one or more combinations of steps of: controlling by the security chip a display screen to display the amount; receiving by the security chip a confirmation instruction input from a keyboard; and receiving a password input from the keyboard and judging whether the password is correct by the security chip.

Further, the method further comprises: controlling by the security chip the display screen to display a prompt to input a confirmation instruction before performing the validation operation by the security chip, if performing the validation operation by the security chip comprises receiving by the security chip a confirmation instruction input from a keyboard; and controlling by the security chip the display screen to display a prompt to input a password before performing the validation operation by the security chip, if performing the validation operation by the security chip comprises receiving a password input from the keyboard and judging whether the password is correct by the security chip.

Further, performing a validation operation by the security chip comprises: controlling by the security chip the display screen to display the amount; or receiving by the security chip the confirmation instruction input from the keyboard; or receiving the password input from the keyboard and judging that the password is correct by the security chip; or controlling the display screen to display the amount and receiving the confirmation instruction input from the keyboard by the security chip; or receiving the confirmation instruction input from the keyboard and controlling the display screen to display the amount by the security chip; or controlling the display screen to display the amount, receiving the password input from the keyboard and judging that the password is correct by the security chip; or receiving the password input from the keyboard, judging that the password is correct and controlling the display screen to display the amount by the security chip; or receiving the confirmation instruction input from the keyboard, receiving the password input from the keyboard and judging that the password is correct by the security chip; or receiving the password input from the keyboard, judging that the password is correct and receiving the confirmation instruction input from the keyboard by the security chip; or controlling the display screen to display the amount, receiving the confirmation instruction input from the keyboard, receiving the password input from the keyboard and judging that the password is correct by the security chip; or controlling the display screen to display the amount, receiving the password input from the keyboard, judging that the password is correct and receiving the confirmation instruction input from the keyboard by the security chip; or receiving the confirmation instruction input from the keyboard, controlling the display screen to display the amount, receiving the password input from the keyboard and judging that the password is correct by the security chip; or receiving the confirmation instruction input from the keyboard, receiving the password input from the keyboard, judging that the password is correct and controlling the display screen to display the amount by the security chip; or receiving the password input from the keyboard, judging that the password is correct, controlling the display screen to display the amount and receiving the confirmation instruction input from the keyboard by the security chip; or receiving the password input from the keyboard, judging that the password is correct, receiving the confirmation instruction input from the keyboard and controlling the display screen to display the amount by the security chip.

Further, the method further comprises: sending by the chip of the smart card second comparison information to the security chip if the amount is greater than or equal to the first threshold and smaller than a second threshold; controlling the display screen to display the amount according to the second comparison information, receiving a confirmation instruction input from a keyboard, and sending the validation success information to the chip of the smart card by the security chip; or controlling the display screen to display the amount according to the second comparison information, receiving a password input from a keyboard, judging that the password is correct, and sending the validation success information to the chip of the smart card by the security chip; sending by the chip of the smart card third comparison information to the security chip if the amount is greater than or equal to the second threshold; controlling the display screen to display the amount according to the third comparison information, receiving a password input from a keyboard, judging that the password is correct, and sending the validation success information to the chip of the smart card by the security chip; or controlling the display screen to display the amount according to the third comparison information, receiving a confirmation instruction input from a keyboard, receiving a password input from the keyboard, judging that the password is correct, and sending the validation success information to the chip of the smart card by the security chip.

Further, the method further comprises: sending by the chip of the smart card second comparison information to the security chip if the amount is larger than or equal to the first threshold and smaller than a second threshold; controlling the display screen to display the amount according to the second comparison information and sending the validation success information to the chip of the smart card by the security chip; or controlling the display screen to display the amount according to the second comparison information, receiving a confirmation instruction input from a keyboard, and sending the validation success information to the chip of the smart card by the security chip; sending by the chip of the smart card third comparison information to the security chip if the amount is greater than or equal to the second threshold and smaller than a third threshold; controlling the display screen to display the amount according to the third comparison information, receiving a confirmation instruction input from a keyboard, and sending the validation success information to the chip of the smart card by the security chip; or controlling the display screen to display the amount according to the third comparison information, receiving a password input from a keyboard, judging that the password is correct, and sending the validation success information to the chip of the smart card by the security chip; sending by the chip of the smart card fourth comparison information to the security chip if the amount is greater than or equal to the third threshold; controlling the display screen to display the amount according to the fourth comparison information, receiving a password input from a keyboard, judging that the password is correct, and sending the validation success information to the chip of the smart card by the security chip; or controlling the display screen to display the amount according to the fourth comparison information, receiving a confirmation instruction input from a keyboard, receiving a password input from the keyboard, judging that the password is correct, and sending the validation success information to the chip of the smart card by the security chip.

Further, before receiving by a chip of the smart card a trade instruction from a card reader through an antenna, the method further comprises: turning on the antenna through a switch; or connecting the antenna with the chip of the smart card through a switch; or turning on the chip of the smart card through a control instruction from the security chip.

Further, after performing by the chip of the smart card the trade operation, the method further comprises: turning off the antenna through a switch; or disconnecting the antenna from the chip of the smart card through a switch; or turning off the chip of the smart card according to a control instruction from the security chip.

Another aspect of the present disclosure further provides a smart card. The smart card comprises a chip, an antenna and a security chip; the antenna is configured to receive a trade instruction from a card reader; the chip of the smart card is configured to analyze the trade instruction to obtain trade information, to judge whether the trade information contains an amount, to compare a prestored first threshold with the amount if the trade information contains the amount, to perform a trade operation according to the trade instruction if the amount is smaller than the first threshold, and to send first comparison information if the amount is greater than or equal to the first threshold; the security chip is configured to receive the first comparison information, to perform a validation operation according to the first comparison information, to send validation success information to the chip of the smart card if the validation operation is successful, and the chip of the smart card is further configured to perform the trade operation according to the validation success information and the trade instruction.

Further, the chip of the smart card comprises: a receiving unit, an analyzing unit, a judging unit, a comparing unit, and an executing unit. The receiving unit is configured to receive the trade instruction from the card reader through the antenna. The analyzing unit is configured to analyze the trade instruction to obtain the trade information. The judging unit is configured to judge whether the trade information contains the information of the amount. The comparing unit is configured to compare the prestored first threshold with the amount if the judging unit determines that the trade information contains the amount. If the amount is smaller than the first threshold, the comparing unit is configured to send execution information to the executing unit, and the executing unit is configured to perform the trade operation according to the execution information and the trade instruction. If the amount is greater than or equal to the first threshold, the comparing unit is configured to send the first comparison information to the security chip, the security chip is configured to perform the validation operation according to the first comparison information and to send the validation success information to the executing unit if the validation operation is successful, and the executing unit is configured to perform the trade operation according to the validation success information and the trade instruction.

Further, the smart card further comprises a display screen and/or a keyboard; the display screen is configured to receive display information of the security chip and to display the display information; and/or the keyboard is configured to input information to the security chip; and the security chip comprises at least one unit selected from a group consisting of: a first validating unit configured to control the display screen to display the amount, a second validating unit configured to receive a confirmation instruction input from the keyboard, and a third validating unit configured to receive a password input from the keyboard and to judge that the password is correct.

Further, if the security chip comprises the second validating unit, the security chip is further configured to control the display screen to display a prompt to input a confirmation instruction; if the security chip comprises the third validating unit, the security chip is further configured to display a prompt to input a password.

Further, the comparing unit comprises: a first comparing module configured to determine that the amount is smaller than the first threshold and to send the execution information to the executing unit; a second comparing module configured to determine that the amount is greater than or equal to the first threshold and smaller than a second threshold and to send second comparison information to the security chip, in which the first validating unit of the security chip is configured to control the display screen to display the amount according to the second comparison information, and the second validating unit is configured to receive the confirmation instruction input from the keyboard and to send the validation success information to the executing unit; or the first validating unit is configured to control the display screen to display the amount according to the second comparison information, and the third validating unit is configured to receive the password input from the keyboard, to judge that the password is correct, and to send the validation success information to the executing unit; and a third comparing module configured to determine that the amount is greater than or equal to the second threshold and to send third comparison information to the security chip, in which the first validating unit of the security chip is configured to control the display screen to display the amount according to the third comparison information, and the third validating unit is configured to receive the password input from the keyboard, to judge that the password is correct, and to send the validation success information to the executing unit; or the first validating unit is configured to control the display screen to display the amount according to the third comparison information, the second validating unit is configured to receive the confirmation instruction input from the keyboard, and the third validating unit is configured to receive the password input from the keyboard, to judge that the password is correct, and to send the validation success information to the executing unit.

Further, the comparing unit comprises: a first comparing module configured to determine that the amount is smaller than the first threshold and to send the execution information to the executing unit; a second comparing module configured to determine that the amount is greater than or equal to the first threshold and smaller than a second threshold and to send second comparison information to the security chip, in which the first validating unit of the security chip is configured to control the display screen to display the amount according to the second comparison information and to send the validation success information to the executing unit; or the first validating unit is configured to control the display screen to display the amount according to the second comparison information, and the second validating unit is configured to receive the confirmation instruction input from the keyboard and to send the validation success information to the executing unit; a third comparing module configured to determine that the amount is greater than or equal to the first threshold and smaller than the second threshold and to send third comparison information to the security chip, in which the first validating unit of the security chip is configured to control the display screen to display the amount according to the third comparison information, and the second validating unit is configured to receive the confirmation instruction input from the keyboard and to send the validation success information to the executing unit; or the first validating unit is configured to control the display screen to display the amount according to the third comparison information, and the third validating unit is configured to receive the password input from the keyboard, to judge that the password is correct, and to send the validation success information to the executing unit; and a fourth comparing module configured to determine that the amount is greater than or equal to the first threshold and smaller than the second threshold and to send fourth comparison information to the security chip, in which the first validating unit of the security chip is configured to control the display screen to display the amount according to the fourth comparison information, and the third validating unit is configured to receive the password input from the keyboard, to judge that the password is correct, and to send the validation success information to the executing unit; or the first validating unit is configured to control the display screen to display the amount according to the fourth comparison information, the second validating unit is configured to receive the confirmation instruction input from the keyboard, and the third validating unit is configured to receive the password input from the keyboard, to judge that the password is correct, and to send the validation success information to the executing unit.

Further, the smart card further comprises a switch disposed on the antenna and configured to turn on or turn off the antenna.

Further, the smart card further comprises a switch connected between the antenna and the chip of the smart card and configured to connect the antenna to or disconnect the antenna from the chip of the smart card.

Further, the switch is a mechanical switch.

Further, the switch is an electrical switch, and the switch is further connected to the security chip and configured to be turned on or turned off according to a control signal from the security chip.

Further, the smart card further comprises a switch button configured to turn on or turn off the mechanical switch.

Further, the smart card further comprises a switch button configured to output a control instruction to the security chip, and the security chip is configured to send the control signal according to the control instruction so as to control the electrical switch to turn on or turn off.

Further, the security chip is further configured to control the chip of the smart card to turn on or turn off, and the chip of the smart card is turned on or turned off under the control of the security chip.

Further, the smart card further comprises a switch button configured to output a control instruction to the security chip, and the security chip is configured to control the chip of the smart card to turn on or turn off according to the control instruction.

Further, the smart card further comprises at least one of a USB interface, a micro USB interface, an audio interface and an irregular interface.

Further, the smart card further comprises a power supply configured to provide power to the smart card.

Further, the security chip is further configured to sign data to obtain signed data and to send the signed data externally.

As can be seen from the technical solutions according to the present disclosure, with the smart card and the method for controlling the smart card trade according to the present disclosure, the chip of the smart card may compare the amount of money to be swiped by the smart card on the card reader with a prestored preset threshold when the smart card is performing a trade on the card reader, and the trade operation is performed after the validation of the security chip is successful. In this way, the smart card has a corresponding security protection function, and thus the trade security is improved.

### BRIEF DESCRIPTION OF THE DRAWINGS

In order to illustrate technical solutions of embodiments of the present disclosure more clearly, a brief introduction of drawings in the description of the embodiments are shown below. Apparently, those described in the drawings are only some embodiments of the present disclosure. For those skilled in the art, other drawings can be obtained according to these drawings, without making creative efforts.

FIG. 1 is a schematic diagram of a smart card according to Embodiment 1 of the present disclosure;

FIG. 2 is a flow chart of a method for controlling a smart card trade according to Embodiment 1 of the present disclosure;

FIG. 3 is a schematic diagram of a smart card according to Embodiment 2 of the present disclosure;

FIG. 4 is a schematic diagram of another smart card according to Embodiment 2 of the present disclosure;

FIG. 5 is a schematic diagram of a smart card according to Embodiment 3 of the present disclosure; and

FIG. 6 is a schematic diagram of a smart card according to Embodiment 4 of the present disclosure.

### DETAILED DESCRIPTION

Technical solutions of embodiments of the present disclosure will be described below clearly and completely with reference to drawings in the embodiments of the present disclosure. Apparently, these described embodiments are solely a part of other than all embodiments of the present disclosure. Embodiments based on the present disclosure and other embodiments obtainable by those skilled in the art without making creative efforts all belong to the protection scope of the present disclosure.

In the specification of the present disclosure, unless specified or limited otherwise, relative terms such as “central”, “longitudinal”, “lateral”, “front”, “rear”, “right”, “left”, “inner”, “outer”, “lower”, “upper”, “horizontal”, “vertical”, “above”, “below”, “up”, “down”, “top”, “bottom” as well as derivative thereof (e.g., “horizontally”, “downwardly”, “upwardly”, etc.) should be construed to refer to the orientation as then described or as shown in the drawings under discussion. These relative terms are for convenience of description and do not require that the present disclosure be constructed or operated in a particular orientation. In addition, terms such as “first” and “second” are used herein for purposes of description and are not intended to indicate or imply relative importance or significance or number.

In the present disclosure, unless specified or limited otherwise, the terms “mounted,” “connected,” “coupled,” “fixed” and the like are used broadly, and may be, for example, fixed connections, detachable connections, or integral connections; may also be mechanical or electrical connections; may also be direct connections or indirect connections via intervening structures; may also be inner communications of two elements, which can be understood by those skilled in the art according to specific situations.

In the following, embodiments of the present disclosure will be described in detail with reference to the drawings.

### Embodiment 1

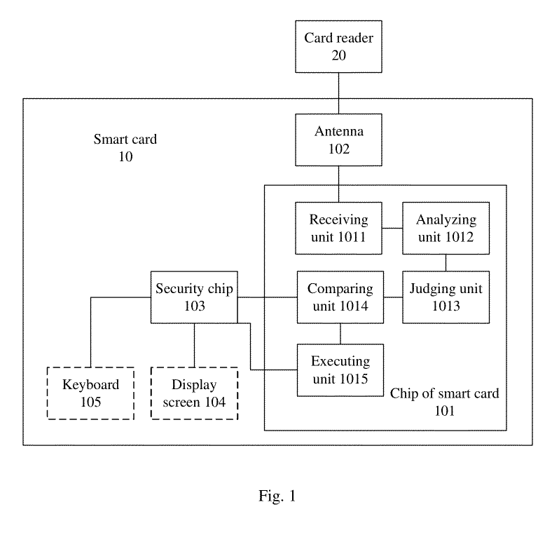

FIG. 1 shows a schematic diagram of a smart card of the present disclosure. As shown in FIG. 1, a smart card 10 includes a chip 101, an antenna 102 and a security chip 103.

The chip 101 of the smart card receives a trade instruction from a card reader 20 through the antenna 102, analyzes the trade instruction to obtain trade information, and judges whether the trade information contains an amount of money. If the trade information contains the amount of money, the chip 101 of the smart card compares a prestored first threshold with the amount of money. If the amount of money is smaller than the first threshold, the chip 101 of the smart card performs a trade operation according to the trade instruction. If the amount of money is greater than or equal to the first threshold, the chip 101 of the smart card sends first comparison information to the security chip 103. The security chip 103 performs a validation operation according to the first comparison information, and sends validation success information to the chip 101 if the validation operation is successful. The chip 101 performs the trade operation according to the validation success information and the trade instruction.

During performing a trade on the card reader using the smart card, the chip 101 of the smart card may compare the amount of money to be swiped by the smart card on the card reader with a prestored preset threshold, and the trade operation is performed after validation of the security chip 103 is successful. In this way, the smart card may have corresponding security protection functions, and the trade security may be ensured even in a case of a large amount trade.

In an embodiment, the chip 101 includes a receiving unit 1011, an analyzing unit 1012, a judging unit 1013, a comparing unit 1014, and an executing unit 1015.

The receiving unit 1011 receives the trade instruction from the card reader through an antenna.

The analyzing unit 1012 analyzes the trade instruction to obtain the trade information.

The judging unit 1013 judges whether the trade information contains the amount of money.

The comparing unit 1014 compares the prestored first threshold with the amount of money if the judging unit 1013 judges that the trade information contains the amount of money.

The comparing unit 1014 sends execution information to the executing unit 1015 if the amount of money is smaller than the first threshold.

The executing unit 1015 performs the trade operation according to the execution information and the trade instruction.

The comparing unit 1014 sends first comparison information to the security chip 103 if the amount of money is greater than or equal to the first threshold.

The security chip 103 performs the validation operation according to the first comparison information, and sends the validation success information to the executing unit 1015 if the validation operation is successful.

The executing unit 1015 performs the trade operation according to the validation success information and the trade instruction.

Therefore, the card reader and the smart card may perform the trade operation directly if the amount of money to be swiped by the smart card on the card reader is smaller than a preset threshold; and the validation operation should be performed before completing the trade operation if the amount of money to be swiped by the smart card on the card reader is greater than or equal to the preset threshold. In this way, the smart card has a trade protection function, and the security of a large amount trade can be ensured.

In addition, the smart card may further include a display screen 104 and/or a keyboard 105. The display screen 104 may receive display information sent from the security chip 103 and display the display information, which ensures that the smart card may display information of the amount of money to be swiped and thus a user may see and confirm the amount. The keyboard 105 may be used to input information to the security chip 103. For example, a user may press a confirmation key in the keyboard 105 to input a confirmation instruction to the security chip 103, or the user may press a number key in the keyboard 105 to input a password to the security chip 103. Therefore, the user may input the confirmation instruction and the password to the security chip 103 through the keyboard 105, which further enhance the security of the smart card trade. Of course, the user may also press a cancel key in the keyboard 105 to input a cancel instruction to the security chip 103, and the security chip 103 instructs the smart card to cancel the trade.

Based on the above description, the security chip 103 includes at least one of following units to perform the validation operation: a first validating unit 1031, a second validating unit 1032 and a third validating unit 1033. The security chip 103 may only include the first validating unit 1031, or only include the second validating unit 1032, or only include the third validating unit 1033. The security chip 103 may include any two validating units of the first validating unit 1031, the second validating unit 1032 and the third validating unit 1033. The security chip 103 may further include three validating units, i.e. the first validating unit 1031, the second validating unit 1032 and the third validating unit 1033.

The first validating unit 1031 controls the display screen to display the amount of money.

The second validating unit 1032 receives a confirmation instruction input from a keyboard.

The third validating unit 1033 receives a password input from the keyboard and judges that the password is correct.

Specifically, the above three validation operations performed by the security chip 103 may be combined in any form, for example, any of the following operations may be applied.

1) The security chip 103 controls the display screen 104 to display the amount of money.

2) The security chip 103 receives a confirmation instruction input from the keyboard 105.

3) The security chip 103 receives a password input from the keyboard 105 and judges that the password is correct.

4) The security chip 103 controls the display screen 104 to display the amount of money and receives the confirmation instruction input from the keyboard 105.

5) The security chip 103 receives the confirmation instruction input from the keyboard 105 and controls the display screen 104 to display the amount of money.

6) The security chip 103 controls the display screen 104 to display the amount of money, receives the password input from the keyboard 105, and judges that the password is correct.

7) The security chip 103 receives the password input from the keyboard 105, judges that the password is correct, and controls the display screen 104 to display the amount of money.

8) The security chip 103 receives the confirmation instruction input from the keyboard 105, receives the password input from the keyboard 105, and judges that the password is correct.

9) The security chip 103 receives the password input from the keyboard 105, judges that the password is correct, and receives the confirmation instruction input from the keyboard 105.

10) The security chip 103 controls the display screen 104 to display the amount of money, receives the confirmation instruction input from the keyboard 105, receives the password input from the keyboard 105, and judges that the password is correct.

11) The security chip 103 controls the display screen 104 to display the amount of money, receives the password input from the keyboard 105, judges that the password is correct, and receives the confirmation instruction input from the keyboard 105.

12) The security chip 103 receives the confirmation instruction input from the keyboard 105, controls the display screen 104 to display the amount of money, receives the password input from the keyboard 105, and judges that the password is correct.

13) The security chip 103 receives the confirmation instruction input from the keyboard 105, receives the password input from the keyboard 105, judges that the password is correct, and controls the display screen 104 to display the amount of money.

14) The security chip 103 receives the password input from the keyboard 105, judges that the password is correct, controls the display screen 104 to display the amount of money, and receives the confirmation instruction input from the keyboard 105.

15) The security chip 103 receives the password input from the keyboard 105, judges that the password is correct, receives the confirmation instruction input from the keyboard 105, and controls the display screen 104 to display the amount of money.

Of course, if the security chip 103 needs to receive the confirmation instruction input from the keyboard 105, the security chip 103 may further control the display screen 104 to display a prompt to input a confirmation instruction, so as to remind the user to perform a confirmation operation. If the security chip 103 needs to receive the password input from the keyboard 105, the security chip 103 may further control the display screen 104 to display a prompt to input a password, so as to remind the user to input the password.

In addition to the execution information and the first validation information, the security chip 103 may further send cancel information to the chip 101 of the smart card. For example, if the security chip 103 judges an operation timeout, the security chip 103 sends the cancel information to the chip 101 of the smart card, such that the smart card cancels the trade. Alternatively, if the security chip 103 judges a password error, the security chip 103 sends the cancel information to the chip 101 of the smart card, such that the smart card cancels the trade. Alternatively, if the security chip 103 receives a cancel instruction sent from the keyboard 105, the security chip 103 sends the cancel information to the chip 101 of the smart card, such that the smart card cancels the trade.

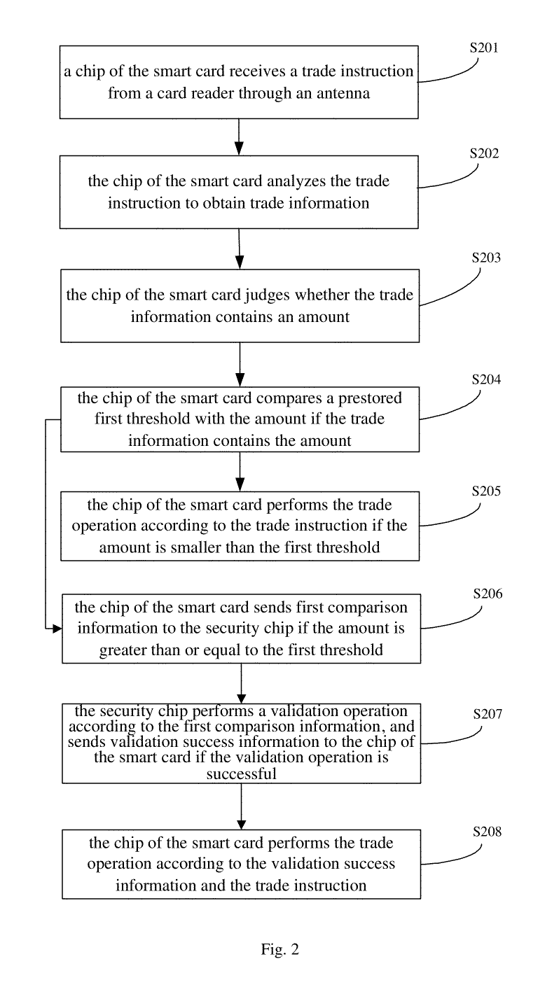

Based on the structure of the smart card shown in FIG. 1, FIG. 2 shows a method for controlling a smart card trade. The method for controlling the smart card trade includes following steps.

At step S201, a chip of the smart card receives a trade instruction from a card reader through an antenna.

Specifically, the chip of the smart card connects to the antenna and to the security chip respectively, and receives the trade instruction from the card reader.

At step S202, the chip of the smart card analyzes the trade instruction to obtain trade information.

Specifically, as the trade instruction from the card reader contains the trade information, the chip of the smart card analyzes the trade instruction to obtain the trade information if the smart card is swiped, which facilitates the judgment of the information contained in the trade information.

At step S203, the chip of the smart card judges whether the trade information contains an amount of money.

Specifically, the chip of the smart card judges whether the trade information contains an amount of money. If the trade information contains the amount of money, step S204 is performed; otherwise, corresponding operations are performed according to commands carried by the trade information.

At step S204, the chip of the smart card compares a prestored first threshold with the amount of money if the trade information contains the amount of money.

Specifically, the chip of the smart card judges whether the present trade is a large amount trade whose trade amount is larger than a preset threshold according to the amount of money contained in the trade information. If the present trade is the large amount trade, the security chip performs a validation operation to ensure the security of the large amount trade.

At step S205, the chip of the smart card performs the trade operation according to the trade instruction if the amount of money is smaller than the first threshold.

Specifically, if the result of the comparison performed by the chip of the smart card shows that the amount of money is smaller than a preset threshold, it is indicated that the present trade needs no validation operation, and the trade operation may be performed directly according to the trade instruction.

At step S206, the chip of the smart card sends first comparison information to the security chip if the amount of money is greater than or equal to the first threshold.

At step S207, the security chip performs a validation operation according to the first comparison information, and sends validation success information to the chip of the smart card if the validation operation is successful.

Specifically, if the result of the comparison performed by the chip of the smart card shows that the amount of money is greater than or equal to the preset threshold, it is indicated that the present trade needs a validation operation. In this condition, the security chip performs the validation operation. The validation operation performed by the security chip includes at least one of the following three operations: the security chip controls the display screen to display the amount of money; the security chip receives the confirmation instruction input from the keyboard; the security chip receives the password input from the keyboard, and judges that the password is correct.

In other words, when determining that the present trade is a large amount trade whose trade amount is greater than a preset threshold, the security chip may control the display screen to display the amount of money so that a user may see the amount of money of the present trade, and the security chip may send validation success information to the chip of the smart card so that the smart card completes the present trade. The security chip may further receive a confirmation instruction input from a keyboard by the user (for example, the user presses a confirmation key to confirm the present trade), and send the validation success information to the chip of the smart card so that the smart card completes the present trade. The security chip may further receive a password input from a keyboard by the user, judge whether the password is correct, and send the validation success information to the chip of the smart card after judging that the password is correct, so that the smart card completes the present trade. Of course, the user may press a cancel key in the keyboard to send a cancel instruction to the security chip, and the security chip instructs the smart card to cancel the trade.

Of course, the above three validation operations performed by the security chip may be combined in any form, for example, any of the following operations may be applied.

1) The security chip controls the display screen to display the amount of money.

2) The security chip receives a confirmation instruction input from the keyboard.

3) The security chip receives a password input from the keyboard and judges that the password is correct.

4) The security chip controls the display screen to display the amount of money and receives the confirmation instruction input from the keyboard.

5) The security chip receives the confirmation instruction input from the keyboard and controls the display screen to display the amount of money.

6) The security chip controls the display screen to display the amount of money, receives the password input from the keyboard, and judges that the password is correct.

7) The security chip receives the password input from the keyboard, judges that the password is correct, and controls the display screen to display the amount of money.

8) The security chip receives the confirmation instruction input from the keyboard, receives the password input from the keyboard, and judges that the password is correct.

9) The security chip receives the password input from the keyboard, judges that the password is correct, and receives the confirmation instruction input from the keyboard.

10) The security chip controls the display screen to display the amount of money, receives the confirmation instruction input from the keyboard, receives the password input from the keyboard, and judges that the password is correct.

11) The security chip controls the display screen to display the amount of money, receives the password input from the keyboard, judges that the password is correct, and receives the confirmation instruction input from the keyboard.

12) The security chip receives the confirmation instruction input from the keyboard, controls the display screen to display the amount of money, receives the password input from the keyboard, and judges that the password is correct.

13) The security chip receives the confirmation instruction input from the keyboard, receives the password input from the keyboard, judges that the password is correct, and controls the display screen to display the amount of money.

14) The security chip receives the password input from the keyboard, judges that the password is correct, controls the display screen to display the amount of money, and receive the confirmation instruction input from the keyboard.

15) The security chip receives the password input from the keyboard, judges that the password is correct, receives the confirmation instruction input from the keyboard, and controls the display screen to display the amount of money.

Of course, if the security chip needs to receive the confirmation instruction input from the keyboard, the security chip may further control the display screen to display a prompt to input a confirmation instruction, so as to remind the user to perform a confirmation operation. If the security chip needs to receive the password input from the keyboard, the security chip may further control the display screen to display a prompt to input a password, so as to remind the user to input the password.

At step S208, the chip of the smart card performs the trade operation according to the validation success information and the trade instruction.

With the method for controlling the smart card trade according to the present disclosure, the chip of the smart card may compare the amount of money to be swiped by the smart card with a prestored preset threshold when the smart card is performing a trade on the card reader, and the trade operation is performed after a validation of the security chip is successful. In this way, the smart card has corresponding security protection functions, and the security of the trade may be ensured even in a case of a large amount trade.

Of course, it is to be understood that, in the present embodiment, the smart card may further include a power supply to provide power to the smart card.

The smart card may further include at least one of a USB interface, a micro USB interface, an audio interface and an irregular interface. Power may be supplied to the smart card via these interfaces, or data transmission may be performed via these interfaces.

The security chip of the smart card may sign the trade information to obtain signed trade information, and send the signed trade information externally to a trade terminal, such as a PC, a mobile phone, a laptop, a tablet computer, etc., such that the function of an electronic signature token may be realized by the smart card.

### Embodiment 2

The present embodiment differs from Embodiment 1 in that the smart card further includes a switch 106 in the present embodiment.

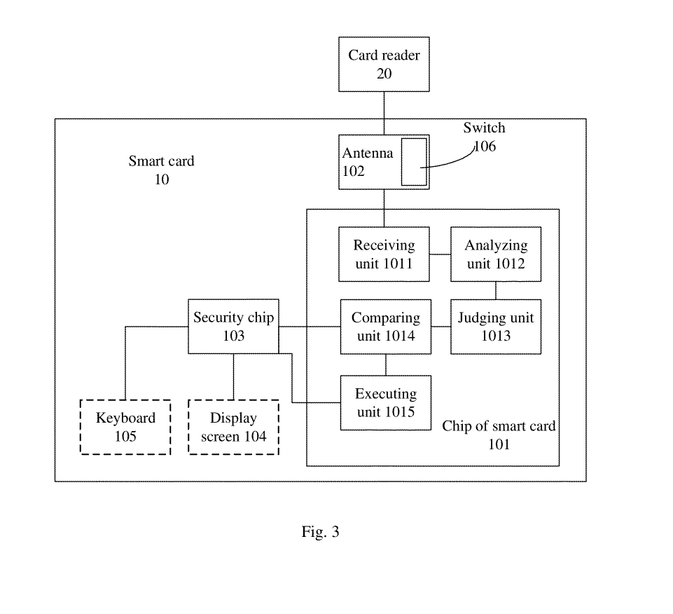

As shown in FIG. 3, the switch 106 may be disposed on the antenna 102 and configured to turn on or turn off the antenna 102.

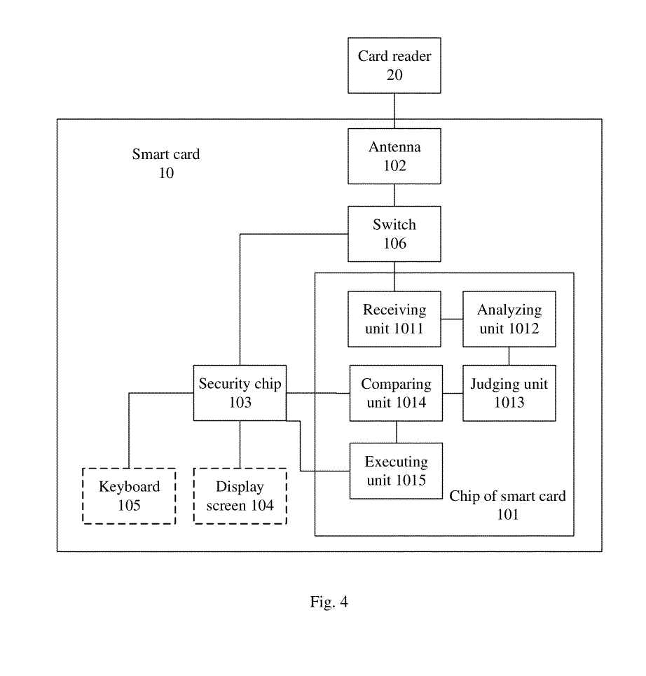

As shown in FIG. 4, the switch 106 is connected to the antenna 102 and to the chip 101 of the smart card, and configured to connect the antenna 102 to or disconnect the antenna 102 from the chip 101 of the smart card.

Of course, the switch 106 may be a mechanical switch. Of course, if the switch 106 is a mechanical switch, the smart card 10 may further include a switch button via which a user may turn on or turn off the mechanical switch, thus providing convenience to user operation. The switch 106 may be an electrical switch. If the switch 106 is an electrical switch, the switch 106 is further connected to the security chip 103 and configured to receive a control signal from the security chip 101 so as to be turned on or turned off. Of course, if the switch 106 is an electrical switch, the smart card 10 may further include a switch button, the user may output a control instruction to the security chip 103 via the switch button, and the security chip 103 may send a control signal according to the control instruction to control the electrical switch to turn on or turn off, thus providing convenience to user operation.

Of course, the security chip may further control the chip 101 of the smart card to turn on or turn off, and the chip 101 of the smart card may further be turned on or turned off under the control of the security chip 103. Of course, the smart card may further include a switch button. The security chip 103 may receive a control instruction output from the switch button of the smart card, and send a control signal according to the control instruction to control the chip 101 of the smart card to turn on or turn off, thus providing convenience to user operation.

The method for controlling the smart card trade according to the present embodiment differs from that in Embodiment 1 in that: in step S201, before the chip of the smart card receives a trade instruction from a card reader through an antenna, the method further includes:

turning on the antenna through a switch; or

connecting the antenna with the chip of the smart card through a switch; or

turning on the chip of the smart card through a control instruction from the security chip.

In step S208, after the smart card performs the trade operation, the method further includes:

turning off the antenna through a switch; or

disconnecting the antenna from the chip of the smart card through a switch; or

turning off the chip of the smart card according to a control instruction from the security chip.

Therefore, before starting the trade or after finishing the trade, the user may turn off the antenna, or the card reader is forbidden to trade with the chip of the smart card through the antenna, thereby preventing an unauthorized trade of the smart card and ensuring the security of the trade.

### Embodiment 3

The present embodiment differs from Embodiment 1 or Embodiment 2 in that: two thresholds are provided so that the chip of the smart card compares the amount of money with these two thresholds, which further enhances the security of the trade.

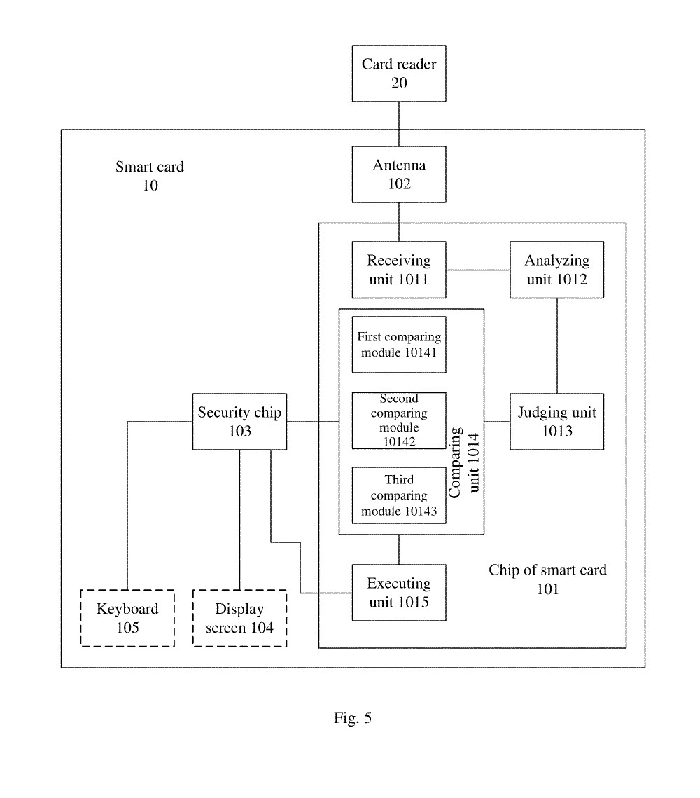

FIG. 5 illustrates a structure of the comparing unit 1014 of the present embodiment based on that in Embodiment 1. The comparing unit 1014 may include: a first comparing module 10141, a second comparing module 10142, and a third comparing module 10143.

The first comparing module 10141 is configured to determine that the amount of money is smaller than the first threshold and to send the execution information to the executing unit 1015.

The second comparing module 10142 is configured to determine that the amount of money is greater than or equal to the first threshold and smaller than a second threshold and to send second comparison information to the security chip 103, such that the security chip 103 performs following operations:

the first validating unit 1031 controls the display screen 104 to display the amount of money, and the second validating unit 1032 receives the confirmation instruction input from the keyboard 105 and sends the validation success information to the executing unit 1015; or

the first validating unit 1031 controls the display screen 104 to display the amount of money, and the third validating unit 1033 receives the password input from the keyboard 105, judges that the password is correct, and sends the validation success information to the executing unit 1015.

The third comparing module 10143 is configured to determine that the amount of money is greater than or equal to the second threshold and to send third comparison information to the security chip 103, such that the security chip 103 performs following operations:

the first validating unit 1031 controls the display screen 104 to display the amount of money, and the third validating unit 1033 receives the password input from the keyboard 105, judges that the password is correct, and sends the validation success information to the executing unit 1015; or

the first validating unit 1031 controls the display screen 104 to display the amount of money, the second validating unit 1032 receives the confirmation instruction input from the keyboard 105, and the third validating unit 1033 receives the password input from the keyboard 105, judges that the password is correct, and sends the validation success information to the executing unit 1015.

Of course, the structure of the comparing unit of the present embodiment may be illustrated based on that in Embodiment 2, details of which are omitted herein.

The method for controlling the smart card trade of the present embodiment further includes:

sending by the chip of the smart card second comparison information to the security chip if the amount of money is greater than or equal to the first threshold and smaller than a second threshold;

controlling the display screen to display the amount of money according to the second comparison information, receiving a confirmation instruction input from a keyboard, and sending the validation success information to the chip of the smart card by the security chip; or controlling the display screen to display the amount of money according to the second comparison information, receiving a password input from a keyboard, judging that the password is correct, and sending the validation success information to the chip of the smart card by the security chip;

sending by the chip of the smart card third comparison information to the security chip if the amount of money is greater than or equal to the second threshold;

controlling the display screen to display the amount of money according to the third comparison information, receiving a password input from a keyboard, judging that the password is correct, and sending the validation success information to the chip of the smart card by the security chip; or controlling the display screen to display the amount of money according to the third comparison information, receiving a confirmation instruction input from a keyboard, receiving a password input from the keyboard, judging that the password is correct, and sending the validation success information to the chip of the smart card by the security chip.

### Embodiment 4

The present embodiment differs from Embodiment 1 or Embodiment 2 in that: three thresholds are provided so that the chip of the smart card compares the amount of money with these three thresholds, which further enhances the security of the trade.

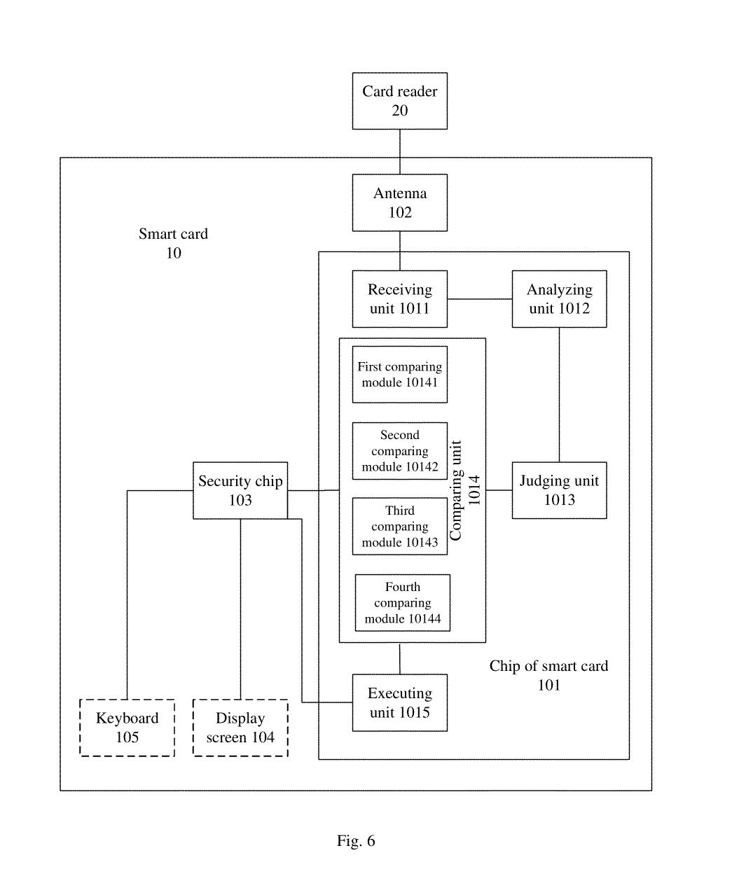

FIG. 6 illustrates a structure of the comparing unit 1014 of the present embodiment based on that in Embodiment 1. The comparing unit 1014 may include: a first comparing module 10141, a second comparing module 10142, a third comparing module 10143, and a fourth comparing module 10144.

The first comparing module 10141 is configured to determine that the amount of money is smaller than the first threshold and to send the execution information to the executing unit 1015.

The second comparing module 10142 is configured to determine that the amount of money is greater than or equal to the first threshold and smaller than a second threshold and to send second comparison information to the security chip 103, such that the security chip 103 performs following operations:

the first validating unit 1031 controls the display screen 104 to display the amount of money and sends the validation success information to the executing unit 1015; or

the first validating unit 1031 controls the display screen 104 to display the amount of money, and the second validating unit 1032 receives the confirmation instruction input from the keyboard 105 and sends the validation success information to the executing unit 1015.

The third comparing module 10143 is configured to determine that the amount of money is greater than or equal to the first threshold and smaller than the second threshold and to send third comparison information to the security chip 103, such that the security chip 103 performs following operations:

the first validating unit 1031 controls the display screen 104 to display the amount of money, and the second validating unit 1032 receives the confirmation instruction input from the keyboard 105 and sends the validation success information to the executing unit 1015; or

the first validating unit 1031 controls the display screen 104 to display the amount of money, and the third validating unit 1033 receives the password input from the keyboard 105, judges that the password is correct, and sends the validation success information to the executing unit 1015.

The fourth comparing module 10144 is configured to determine that the amount of money is greater than or equal to the first threshold and smaller than the second threshold and to send fourth comparison information to the security chip 103, such that the security chip 103 performs following operations:

the first validating unit 1031 controls the display screen 104 to display the amount of money, and the third validating unit 1033 receives the password input from the keyboard 105, judges that the password is correct, and sends the validation success information to the executing unit 1015; or

the first validating unit 1031 controls the display screen 104 to display the amount of money, the second validating unit 1032 receives the confirmation instruction input from the keyboard 105, and the third validating unit 1033 receives the password input from the keyboard 105, judges that the password is correct, and sends the validation success information to the executing unit 1015.

Of course, the structure of the comparing unit of the present embodiment may be illustrated based on that in Embodiment 2, details of which are omitted herein.

The method for controlling the smart card trade of the present embodiment further includes:

sending by the chip of the smart card second comparison information to the security chip if the amount of money is larger than or equal to the first threshold and smaller than a second threshold;

controlling the display screen to display the amount of money according to the second comparison information and sending the validation success information to the chip of the smart card by the security chip; or controlling the display screen to display the amount of money according to the second comparison information, receiving a confirmation instruction input from a keyboard, and sending the validation success information to the chip of the smart card by the security chip;

sending by the chip of the smart card third comparison information to the security chip if the amount of money is greater than or equal to the second threshold and smaller than a third threshold;

controlling the display screen to display the amount of money according to the third comparison information, receiving a confirmation instruction input from a keyboard, and sending the validation success information to the chip of the smart card by the security chip; or controlling the display screen to display the amount of money according to the third comparison information, receiving a password input from a keyboard, judging that the password is correct, and sending the validation success information to the chip of the smart card by the security chip;

sending by the chip of the smart card fourth comparison information to the security chip if the amount of money is greater than or equal to the third threshold;

controlling the display screen to display the amount of money according to the fourth comparison information, receiving a password input from a keyboard, judging that the password is correct, and sending the validation success information to the chip of the smart card by the security chip; or controlling the display screen to display the amount of money according to the fourth comparison information, receiving a confirmation instruction input from a keyboard, receiving a password input from the keyboard, judging that the password is correct, and sending the validation success information to the chip of the smart card by the security chip.

Any procedure or method described in the flow charts or described in any other way herein may be understood to comprise one or more modules, portions or parts for storing executable codes that realize particular logic functions or procedures. Moreover, advantageous embodiments of the present disclosure comprises other implementations in which the order of execution is different from that which is depicted or discussed, including executing functions in a substantially simultaneous manner or in an opposite order according to the related functions. This should be understood by those skilled in the art to which embodiments of the present disclosure belong.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks, CD, etc.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure. The scope of the present disclosure is defined by the appended claims and equivalents thereof.

1. A method for controlling a smart card trade, comprising:
receiving by a chip of the smart card a trade instruction from a card reader through an antenna;
analyzing by the chip of the smart card the trade instruction to obtain trade information;
judging by the chip of the smart card whether the trade information contains an amount;
comparing by the chip of the smart card the amount with a prestored first threshold if the trade information contains the amount;
performing by the chip of the smart card a trade operation according to the trade instruction if the amount is smaller than the first threshold;
sending first comparison information to a security chip if the amount is greater than or equal to the first threshold;
performing by the security chip a validation operation according to the first comparison information, and sending validation success information to the chip of the smart chip by the security chip if the validation operation is successful; and
performing by the chip of the smart card the trade operation according to the validation success information and the trade instruction.

2. The method according to claim 1, wherein performing a validation operation by the security chip comprises one or more combinations of steps of:
controlling by the security chip a display screen to display the amount;
receiving by the security chip a confirmation instruction input from a keyboard; and
receiving a password input from the keyboard and judging whether the password is correct by the security chip.

3. The method according to claim 2, further comprising:
controlling by the security chip the display screen to display a prompt to input a confirmation instruction before performing the validation operation by the security chip, if performing the validation operation by the security chip comprises receiving by the security chip a confirmation instruction input from a keyboard; and
controlling by the security chip the display screen to display a prompt to input a password before performing the validation operation by the security chip, if performing the validation operation by the security chip comprises receiving a password input from the keyboard and judging whether the password is correct by the security chip.

4. The method according to claim 1, further comprising:
sending by the chip of the smart card second comparison information to the security chip if the amount is greater than or equal to the first threshold and smaller than a second threshold;
controlling the display screen to display the amount according to the second comparison information, receiving a confirmation instruction input from a keyboard, and sending the validation success information to the chip of the smart card by the security chip; or controlling the display screen to display the amount according to the second comparison information, receiving a password input from a keyboard, judging that the password is correct, and sending the validation success information to the chip of the smart card by the security chip;
sending by the chip of the smart card third comparison information to the security chip if the amount is greater than or equal to the second threshold;
controlling the display screen to display the amount according to the third comparison information, receiving a password input from a keyboard, judging that the password is correct, and sending the validation success information to the chip of the smart card by the security chip; or controlling the display screen to display the amount according to the third comparison information, receiving a confirmation instruction input from a keyboard, receiving a password input from the keyboard, judging that the password is correct, and sending the validation success information to the chip of the smart card by the security chip.

5. The method according to claim 1, further comprising:
sending by the chip of the smart card second comparison information to the security chip if the amount is larger than or equal to the first threshold and smaller than a second threshold;
controlling the display screen to display the amount according to the second comparison information and sending the validation success information to the chip of the smart card by the security chip; or controlling the display screen to display the amount according to the second comparison information, receiving a confirmation instruction input from a keyboard, and sending the validation success information to the chip of the smart card by the security chip;
sending by the chip of the smart card third comparison information to the security chip if the amount is greater than or equal to the second threshold and smaller than a third threshold;
controlling the display screen to display the amount according to the third comparison information, receiving a confirmation instruction input from a keyboard, and sending the validation success information to the chip of the smart card by the security chip; or controlling the display screen to display the amount according to the third comparison information, receiving a password input from a keyboard, judging that the password is correct, and sending the validation success information to the chip of the smart card by the security chip;
sending by the chip of the smart card fourth comparison information to the security chip if the amount is greater than or equal to the third threshold;
controlling the display screen to display the amount according to the fourth comparison information, receiving a password input from a keyboard, judging that the password is correct, and sending the validation success information to the chip of the smart card by the security chip; or controlling the display screen to display the amount according to the fourth comparison information, receiving a confirmation instruction input from a keyboard, receiving a password input from the keyboard, judging that the password is correct, and sending the validation success information to the chip of the smart card by the security chip.

6. The method according to claim 1, wherein before receiving by a chip of the smart card a trade instruction from a card reader through an antenna, the method further comprises:
turning on the antenna through a switch; or
connecting the antenna with the chip of the smart card through a switch; or
turning on the chip of the smart card through a control instruction from the security chip.

7. The method according to claim 1, wherein after performing by the chip of the smart card the trade operation, the method further comprises:
turning off the antenna through a switch; or
disconnecting the antenna from the chip of the smart card through a switch; or
turning off the chip of the smart card according to a control instruction from the security chip.

8. A smart card, comprising:
an antenna configured to receive a trade instruction from a card reader;
a chip of the smart card configured to analyze the trade instruction to obtain trade information, to judge whether the trade information contains an amount, to compare a prestored first threshold with the amount if the trade information contains the amount, to perform a trade operation according to the trade instruction if the amount is smaller than the first threshold, and to send first comparison information if the amount is greater than or equal to the first threshold;
a security chip configured to receive the first comparison information, to perform a validation operation according to the first comparison information, to send validation success information to the chip of the smart card if the validation operation is successful, such that the chip of the smart card is further configured to perform the trade operation according to the validation success information and the trade instruction.

9. The smart card according to claim 8, wherein the chip of the smart card comprises:
a receiving unit configured to receive the trade instruction from the card reader through the antenna;
an analyzing unit configured to analyze the trade instruction to obtain the trade information;
a judging unit configured to judge whether the trade information contains the information of the amount;
a comparing unit configured to compare the prestored first threshold with the amount if the judging unit determines that the trade information contains the amount, to generate execution information if the amount is smaller than the first threshold, or to generate the first comparison information if the amount is greater than or equal to the first threshold, in which the security chip is configured to perform the validation operation according to the first comparison information and to generate the validation success information if the validation operation is successful; and
an executing unit configured to perform the trade operation according to the execution information and the trade instruction, or to perform the trade operation according to the validation success information and the trade instruction.

10. The smart card according to claim 9, further comprising a display screen and/or a keyboard;
wherein the display screen is configured to receive display information of the security chip and to display the display information;
the keyboard is configured to input information to the security chip; and
the security chip comprises at least one unit selected from a group consisting of: a first validating unit configured to control the display screen to display the amount, a second validating unit configured to receive a confirmation instruction input from the keyboard, and a third validating unit configured to receive a password input from the keyboard and to judge that the password is correct.

11. The smart card according to claim 10, wherein the security chip is further configured to: control the display screen to display a prompt to input a confirmation instruction, and/or to display a prompt to input a password.

12. The smart card according to claim 11, wherein the comparing unit comprises:
a first comparing module configured to determine that the amount is smaller than the first threshold and to send the execution information to the executing unit;
a second comparing module configured to determine that the amount is greater than or equal to the first threshold and smaller than a second threshold and to send second comparison information to the security chip, in which the first validating unit of the security chip is configured to control the display screen to display the amount according to the second comparison information, and the second validating unit is configured to receive the confirmation instruction input from the keyboard and to send the validation success information to the executing unit; or the first validating unit is configured to control the display screen to display the amount according to the second comparison information, and the third validating unit is configured to receive the password input from the keyboard, to judge that the password is correct, and to send the validation success information to the executing unit; and
a third comparing module configured to determine that the amount is greater than or equal to the second threshold and to send third comparison information to the security chip, wherein the first validating unit of the security chip is configured to control the display screen to display the amount according to the third comparison information, and the third validating unit is configured to receive the password input from the keyboard, to judge that the password is correct, and to send the validation success information to the executing unit; or the first validating unit is configured to control the display screen to display the amount according to the third comparison information, the second validating unit is configured to receive the confirmation instruction input from the keyboard, and the third validating unit is configured to receive the password input from the keyboard, to judge that the password is correct, and to send the validation success information to the executing unit.

13. The smart card according to claim 10, wherein the comparing unit comprises:
a first comparing module configured to determine that the amount is smaller than the first threshold and to send the execution information to the executing unit;
a second comparing module configured to determine that the amount is greater than or equal to the first threshold and smaller than a second threshold and to send second comparison information to the security chip, wherein the first validating unit of the security chip is configured to control the display screen to display the amount according to the second comparison information and to send the validation success information to the executing unit; or the first validating unit is configured to control the display screen to display the amount according to the second comparison information, and the second validating unit is configured to receive the confirmation instruction input from the keyboard and to send the validation success information to the executing unit;
a third comparing module configured to determine that the amount is greater than or equal to the second threshold and smaller than a third threshold and to send third comparison information to the security chip, wherein the first validating unit of the security chip is configured to control the display screen to display the amount according to the third comparison information, and the second validating unit is configured to receive the confirmation instruction input from the keyboard and to send the validation success information to the executing unit; or the first validating unit is configured to control the display screen to display the amount according to the third comparison information, and the third validating unit is configured to receive the password input from the keyboard, to judge that the password is correct, and to send the validation success information to the executing unit; and
a fourth comparing module configured to determine that the amount is greater than or equal to the third threshold and to send fourth comparison information to the security chip, wherein the first validating unit of the security chip is configured to control the display screen to display the amount according to the fourth comparison information, and the third validating unit is configured to receive the password input from the keyboard, to judge that the password is correct, and to send the validation success information to the executing unit; or the first validating unit is configured to control the display screen to display the amount according to the fourth comparison information, the second validating unit is configured to receive the confirmation instruction input from the keyboard, and the third validating unit is configured to receive the password input from the keyboard, to judge that the password is correct, and to send the validation success information to the executing unit.

14. The smart card according to claim 8, further comprising a switch disposed on the antenna and configured to turn on or turn off the antenna.

15. The smart card according to claim 8, further comprising a switch connected between the antenna and the chip of the smart card and configured to connect the antenna to or disconnect the antenna from the chip of the smart card.

16. (canceled)

17. The smart card according to claim 14, wherein the switch is an electrical switch, and the switch is further connected to the security chip and configured to be turned on or turned off according to a control signal from the security chip.

18. (canceled)

19. The smart card according to claim 17, further comprising a switch button configured to output a control instruction to the security chip, and the security chip is configured to send the control signal according to the control instruction so as to control the electrical switch to turn on or turn off.

20. The smart card according to claim 8, wherein the security chip is further configured to control the chip of the smart card to turn on or turn off.

21. The smart card according to claim 20, further comprising a switch button configured to output a control instruction to the security chip, and the security chip is configured to control the chip of the smart card to turn on or turn off according to the control instruction.

22. (canceled)

23. (canceled)

24. The smart card according to claim 8, wherein the security chip is further configured to sign data to obtain signed data and to send the signed data externally.
